(19) United States
(12) Patent Application Publication
(10) Pub. No.: US 2007/0155560 A1
(43) Pub. Date: Jul. 5, 2007

(54) Linear actuator

(76) Inventors: Robert W. Horst, San Jose, CA (US); Richard R. Marcus, Mountain View, CA (US)

Correspondence Address: PERKINS COIE LLP, P.O. BOX 2168, MENLO PARK, CA, 94026, US

(21) Appl. No.: 11/649,493

(22) Filed: Jan. 3, 2007

Related U.S. Application Data
(60) Provisional application No. 60/755,466, filed on Dec. 30, 2005.

(51) Int. Cl. F16H 7/12; F16H 7/14

(52) U.S. Cl. 474/134; 474/117; 474/133; 474/114

(57) ABSTRACT

A linear actuator is driven by an internal motor and delivers force to an output shaft. Advantageously, the technique provides speed/force tradeoffs via a simple, high-efficiency mechanism; continuous output force is provided by alternating the load between two belts deflected by, by way of example but not limitation, cam devices. The technique provides high force, allows the force to be traded for speed at a given power level, and provides continuous output force when operated as an actuator or continuous braking force when operated as a generator. Sensors may provide a low power tracking mode to allow the output to move freely.

### CROSS REFERENCE TO RELATED APPLICATIONS

This Application claims the benefit of U.S. Provisional Application No. 60/755,466 filed Dec. 30, 2005, the disclosure of which is incorporated herein by reference.

### BACKGROUND

Motors and actuators are used in a wide variety of applications. Many applications, including robotics and active orthotics, require characteristics similar to human muscles. The characteristics include the ability to deliver high force at a relatively low speed and to allow free-movement when power is removed, thereby allowing a limb to swing freely during portions of the movement cycle. This may call for an actuator that can supply large forces at slow speeds and smaller forces at higher speeds, or a variable ratio transmission (VRT) between the primary driver input and the output of an actuator.

In the past, several different techniques have been used to construct a VRT. Some examples of implementations of VRTs include Continuously Variable Transmissions (CVTs) and Infinitely Variable Transmissions (IVTs). The underlying principle of most previous CVTs is to change the ratio of one or more gears by changing the diameter of the gear, changing the place where a belt rides on a conical pulley, or by coupling forces between rotating disks with the radius of the intersection point varying based on the desired ratio. Prior art CVTs have drawbacks in efficiency, complexity, maximum torque, and range of possible ratios.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A linear actuator is driven by an internal motor and delivers force to an output shaft. Advantageously, the technique provides speed/force tradeoffs via a simple, high-efficiency mechanism; continuous output force is provided by alternating the load between two belts deflected by, by way of example but not limitation, cam devices. The technique provides high force, allows the force to be traded for speed at a given power level, and provides continuous output force when operated as an actuator or continuous braking force when operated as a generator. Sensors may provide a low power tracking mode to allow the output to move freely.

The technique may be used to construct actuators for active orthotics, robotics or other applications. Versions with passive clutches may also be used to construct variable-ratio motor gearheads, or may be scaled up to build continuously variable transmissions for automobiles, bicycles, or other vehicles.

### BRIEF DESCRIPTION OF THE DRAWINGS

Embodiments of the invention are illustrated in the figures. However, the embodiments and figures are illustrative rather than limiting; they provide examples of the invention.

FIGS. 1A and 1B are diagrams illustrating a principle of operation.

FIG. 2 depicts an example of a variable ratio linear actuator system.

FIG. 3A, 3B, and 3C are flowcharts of methods for actuator-mode operation of a lead screw-braked actuator.

FIG. 4 is a graph illustrating continuous force as tension is passed from one belt to another belt.

FIG. 5 depicts another example of a variable ratio linear actuator system.

FIGS. 6A and 6B depict another example of a linear actuator system.

FIGS. 7A and 7B depict an example of linear actuator system with an output piston that is pushed or pulled depending on the position of a lead-screw driven carriage.

FIGS. 8A and 8B depict drawings of a specific implementation of a linear actuator system.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

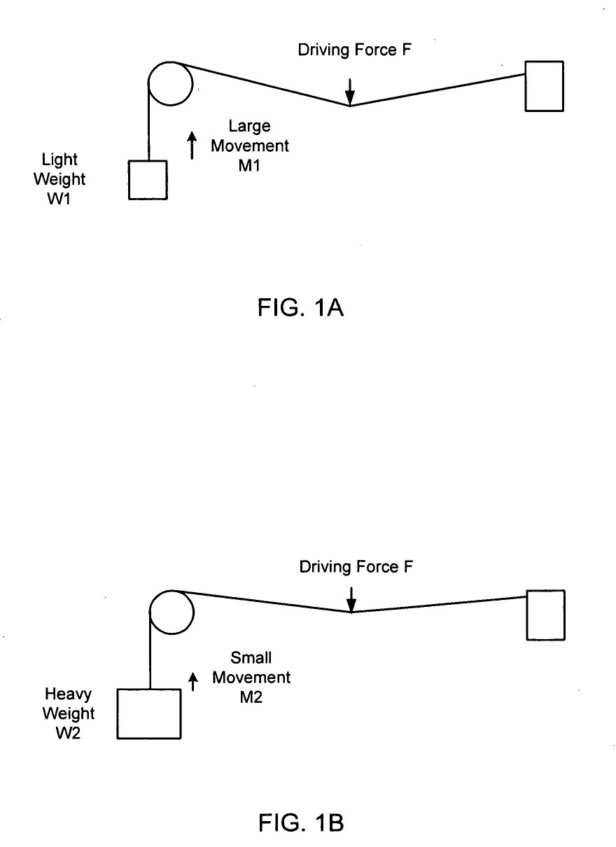

FIGS. 1A and 1B illustrate a principle of operation useful for an understanding of the teachings provided herein. FIGS. 1A and 1B show how a force can be used to deflect a belt and exert a strong force over a short distance or a weak force over a longer distance. FIG. 1A shows weight W1 attached to a rope that is anchored at one end and supported by a pulley. A force F deflects the rope near the middle and force F causes weight W1 to be lifted a distance M1. FIG. 1b shows that when the weight is replaced by a heavier weight W2, the same driving force F causes it to be lifted a smaller distance M2. Hence the rope has provided a variable transmission between the driving force F and the resisting force applied by the weight. By constructing a device that allows for multiple sequential deflections of a flexible belt, this principle can be used to construct a variety of actuators and transmissions.

U.S. patent application Ser. No. 11/033,368, which was filed on Jan. 13, 2005, and which is incorporated by reference, describes a high torque “pinch” motor with a variable ratio coupling between a driver and output. The motor includes a flexible disk or belt that couples a braking pulley and an output pulley. The output is alternately advanced or held in place while the driver returns to the position where it can again deflect the belt or disk to advance the output. However, the design does not allow for continuous output torque.

U.S. patent application Ser. No. ______ (Attorney Docket No. 57162-8002.US01) entitled “Rotary Actuator” by Horst et al. filed concurrently herewith is incorporated by reference. U.S. patent application Ser. No. ______ (Attorney Docket No. 57162-8010.US01) entitled “Continuously Variable Transmission” by Horst et al. filed concurrently herewith is incorporated by reference. U.S. patent application Ser. No. ______ (Attorney Docket No. 57162-8011.US01) entitled “Deflector Assembly” by Horst et al. filed concurrently herewith is incorporated by reference.

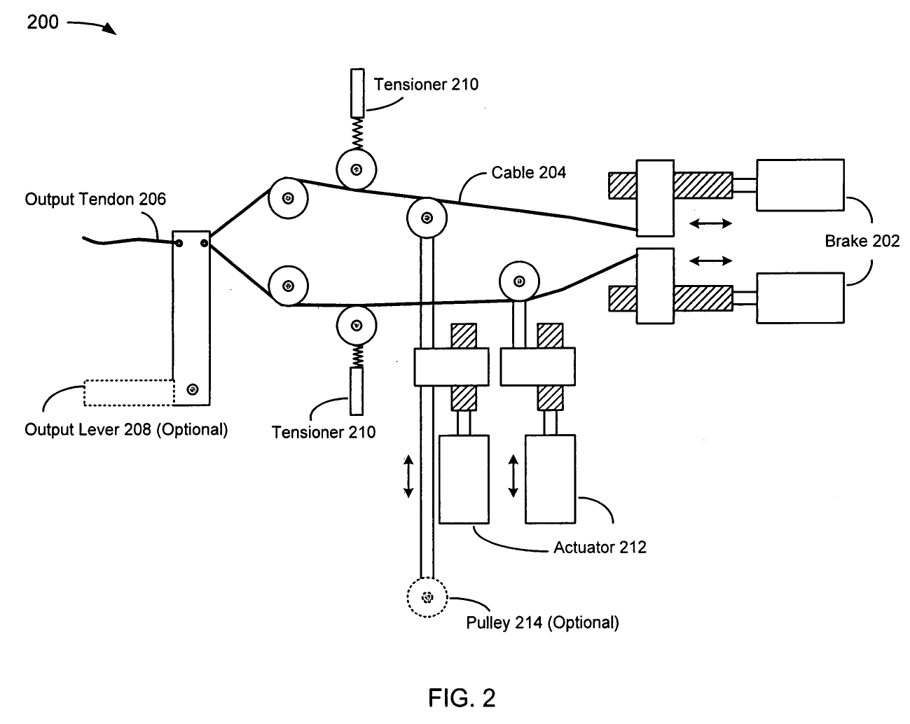

FIG. 2 depicts an example of a variable ratio linear actuator system 200. The system 200 includes two brakes 202, two cables 204, an output tendon 206, an optional output lever 208, two tensioners 210, two actuators 212, and an optional pulley 214. In an illustrative embodiment, the brakes 202 are implemented as lead screw/nuts with a lead angle steep enough to prevent backdriving the screw when a load is applied to the nut. However, any applicable known or convenient device capable of acting as a brake could be used. In the example of FIG. 2, the brake 202 is coupled to the cables 204. In the illustrative embodiment, each cable 204 is attached to each nut of the lead screw/nuts.

In the example of FIG. 2, the cables 204 are coupled to approximately the same point of a lever which is coupled to an output tendon 206 and/or an output lever 208.

In an illustrative embodiment, the cables 204 have tensioners 210 at the top and bottom of each of the cables 204. Advantageously, the tensioners 210 may facilitate forward and reverse operation. The tensioners 210 may have magnets attached to change the magnetic field at linear hall-effect sensors mounted to a housing (not shown). The hall-effect sensors may be read by controlling electronics and used to determine belt tension at the top and bottom of each cable 204. The belt tension can be used to determine the force being supplied to or from the output. The force sensors may be used, by way of example but not limitation, to control the operation of lead screw motors or to sense movement of motor output from external forces.

Each of the cables 204 has an actuator 212 that applies driving force to deflect the belt. In an illustrative embodiment, the ratio is determined by the displacement of each actuator 212. When a low ratio is desired, the controlling electronics drives each actuator 212 for a short time before switching to the other. Thus the controlling electronics or computer can set the ratio as desired. In other illustrative embodiments, there are at least three different ways of running, for example, ball screw deflectors: 1) Use electronics to drive to a fixed deflection amount to set a fixed ratio, 2) Drive each actuator for a fixed time, and 3) Drive each actuator until a fixed current is reached. These different ways will likely be associated with slightly different behavior, but those of skill in the relevant art with this reference before them will have little difficulty understanding the repercussions of choosing one way over another.

In an illustrative embodiment, the actuators 212 are implemented as ball screw/nuts, which are backdrivable. However, any applicable known or convenient actuator could be used. If a regenerative braking mode is desired, the drivers should be back drivable. Ball screw actuators are a type of lead screw with recirculating ball bearings and that allows them to be back driven from the load. Hence in this illustrative embodiment, tension on the cables 204 can force the ball screw actuators 212 to rotate to allow driver motors to be run as generators.

The system 200 may or may not apply force in only one direction. For example, the system 200 can pull the tendon 206, or rotate the lever arm 208 clockwise, but may be unable to drive significant force in the counter clockwise direction. A second pair of cables can be added to pull a second tendon or lever for the opposite direction. The added cables do not require adding more motors or lead screws. The pulleys 214 (only one of which is illustrated in the example of FIG. 2 to avoid cluttering the figure) can be used to engage the second pair of cables.

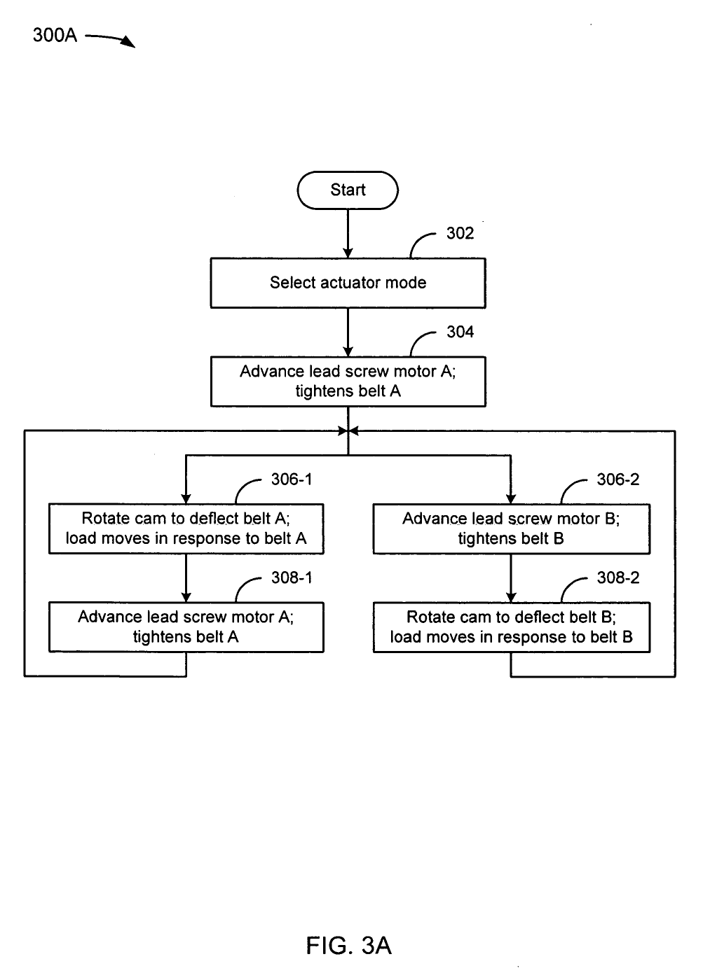

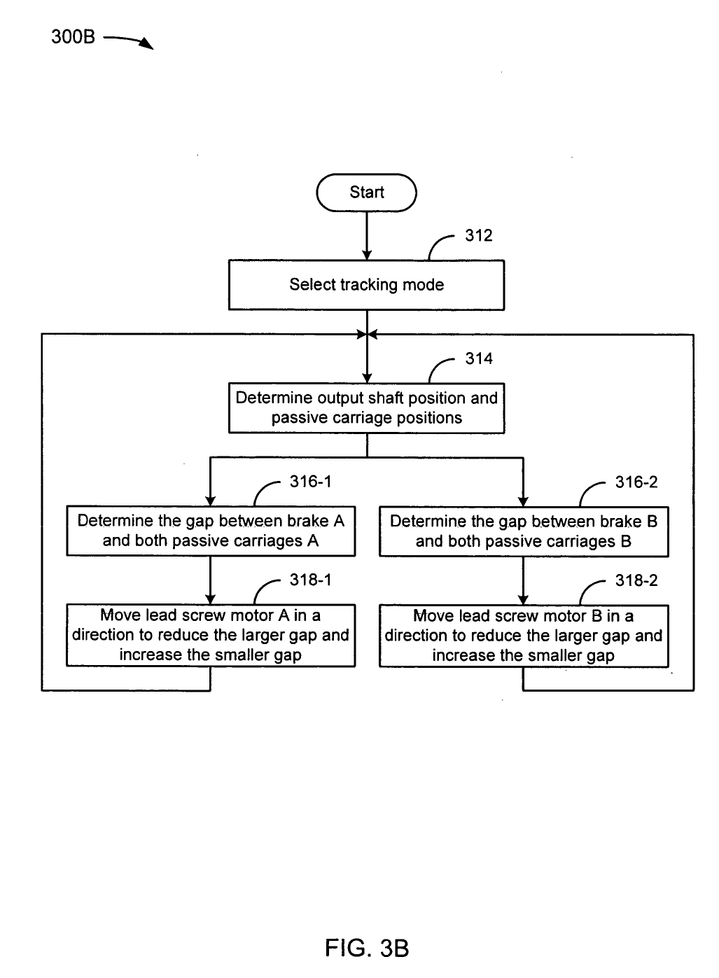

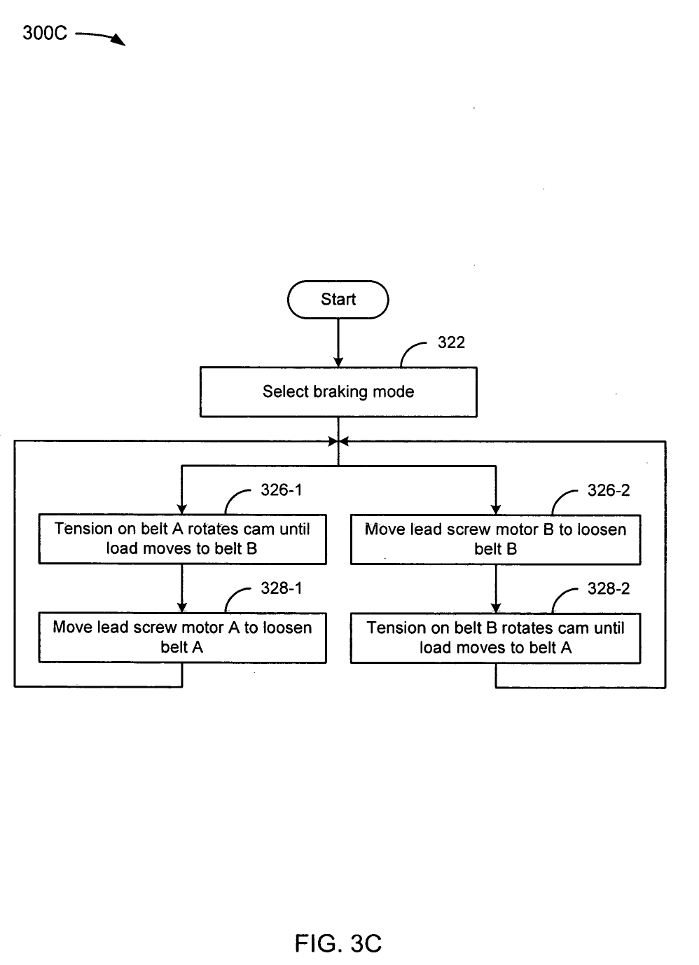

FIG. 3A is a flowchart 300A showing operation of a lead screw-braked device in actuator mode. This method and other methods are depicted as modules arranged serially or in parallel. However, modules of the methods may be reordered, or arranged for parallel or serial execution as appropriate. FIG. 3A is intended to illustrate an actuator mode of a continuous variable ratio actuator.

In the example of FIG. 3A, the flowchart 300A starts at module 302 with selecting actuator mode. The flowchart 300A continues at module 304 with advancing lead screw motor A. Lead screw motor A may be either of dual (or more) lead screw motors that are part of a lead screw brake assembly of a continuously variable ratio actuator. The result of advancing lead screw motor A is that belt A is tightened. Belt A may be either of dual (or more) belts that are part of a continuous variable ratio motor. It may be noted that the module 304 is optional in that if belt A is already tightened, the module 304 is not necessary to tighten belt A. The necessity of module 304, therefore, is dependent upon implementation and/or circumstances.

In the example of FIG. 3A, the flowchart 300A continues at modules 306-1 and 306-2, which are executed simultaneously. It may be noted that precise simultaneous execution may be impossible to achieve. Accordingly, “simultaneous” is intended to mean substantially simultaneous, or approximately simultaneous. Moreover, certain applications may require more or less accurate approximations of simultaneity. At module 306-1, a cam is rotated to deflect belt A. This has the result of moving a load in response to the deflection of belt A. At module 306-2, lead screw motor B is advanced to tighten belt B. Thus, the cam is rotated to deflect belt A while simultaneously tightening belt B.

In the example of FIG. 3A, the flowchart 300A continues at modules 308-1 and 308-2, which are executed simultaneously. At module 308-1, lead screw motor A is advanced to tighten belt A. At module 308-2, the cam is rotated to deflect belt B, and the load may be moved thereby. Thus, the cam is rotated to deflect belt B while simultaneously tightening belt A.

In the example of FIG. 3A, the flowchart 300A continues at the modules 306-1, 306-2, as described previously. In this way, continuous motion of the output is sustained. It should be noted that the flowchart 300A makes reference to a single cam, but that two cams could be used in alternative embodiments (e.g., a cam A and a cam B).

FIG. 3B is a flowchart 300B showing operation of a lead screw-braked device in tracking mode. FIG. 3B is intended to illustrate a tracking mode of a continuously variable ratio actuator. In the example of FIG. 3B, the flowchart 300B starts at module 312 with selecting tracking mode.

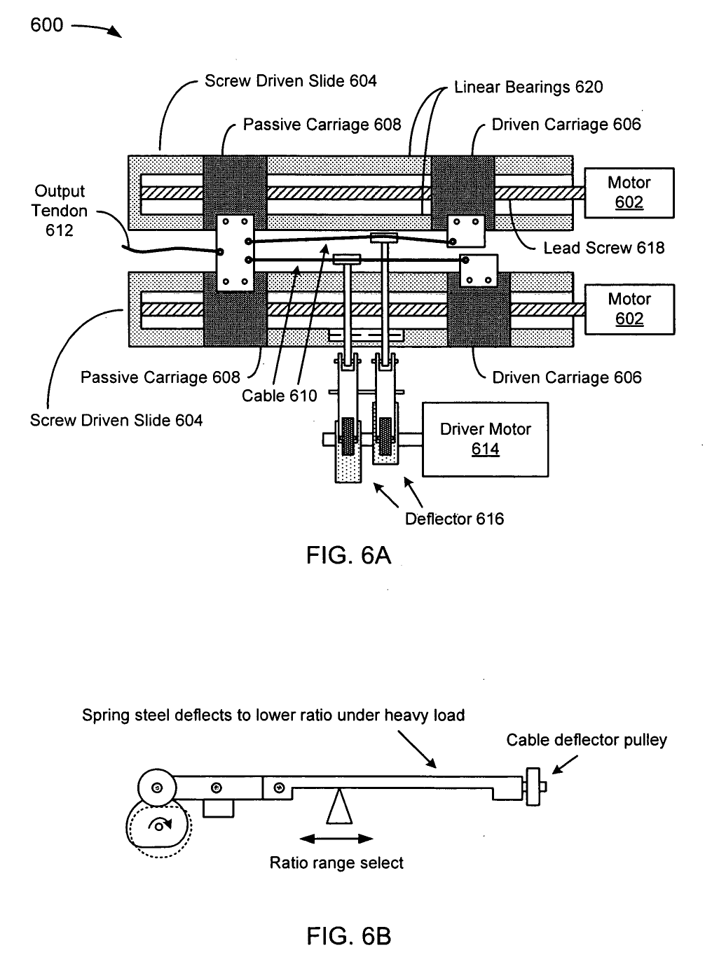

In the example of FIG. 3B, the flowchart 300B continues at module 314 with determining output shaft position and passive carriage positions. Passive carriages are described later with reference to FIGS. 6, 7, and 8. The flowchart 300B continues at modules 316-1 and 316-2, which may or may not be executed simultaneously. At the module 316-1, a gap between brake A and both passive carriages A is determined. At the module 316-2, a gap between brake B and both passive carriages B is determined.

In the example of FIG. 3B, the flowchart 300B continues at modules 318-1 and 318-2, which may or may not be executed simultaneously. At the module 318-1, the lead screw motor A is moved in a direction to reduce the larger gap and increase the smaller gap. At the module 318-2, the lead screw motor B is moved in a direction to reduce the larger gap and increase the smaller gap.

The flowchart 300B continues at module 314 as described previously. In this way, the tracking mode can continue until the tracking mode is exited. It should be noted that it may be impossible to entirely equalize the larger and smaller gaps, and different applications may demand different degrees of success in equalizing the gaps.

FIG. 3C is a flowchart 300C showing operation of a lead screw-braked device in braking mode. FIG. 3C is intended to illustrate a braking mode of a continuous variable ratio actuator. It may be noted that in braking mode, the cam moves in the opposite direction to its motion in actuator mode. In the example of FIG. 3C, the flowchart 300C starts at module 322 with selecting braking mode.

In the example of FIG. 3C, the flowchart 300C continues at modules 326-1 and 326-2, which may be executed simultaneously. At the module 326-1, tension on belt A rotates a cam until a load moves to belt B. At the module 326-2, lead screw motor B is moved to loosen belt B. When an external force is applied, one of the belts becomes tight at the top or bottom, and that tension pulls against the cam to cause it to rotate. While that belt is supporting the load, the other lead screw motor loosens the other belt. The amount of loosening is chosen such that the load is passed from the first to the second belt before the first cam is rotated to its minimum displacement position.

In an embodiment, when the cam is being moved by the belt, energy can be recaptured by using the driver motor as a generator. Hence this mode can be used for regenerative braking or as a generator. In another embodiment, where the braking force is insufficient to rotate the cam, the cam motor can be controlled to force the appropriate rotation of the cam.

In the example of FIG. 3C, the flowchart 300C continues at modules 328-1 and 328-2, which may be executed simultaneously. At the module 328-1, lead screw motor A is moved to loosen belt A. At the module 328-2, tension on belt B rotates the cam until the load moves to belt A. The flowchart 300C then returns to the modules 326-1 and 326-2 to repeat the modules while in braking mode.

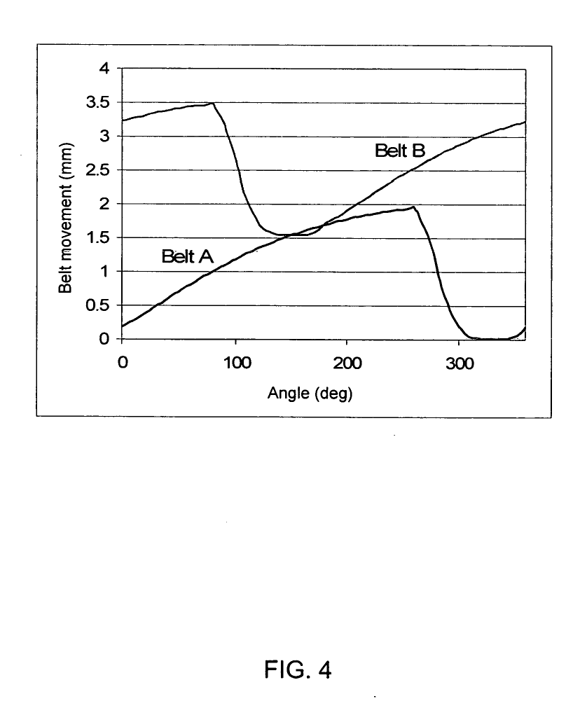

FIG. 4 shows a plot of the rotation angle of the two cams versus the change in belt length caused by the deflection of the belt. The change of length of the belt causes the output shaft to move by the same amount. Hence the Y axis of FIG. 4 can also be considered the movement of the output shaft as it is moved in response to the two belts. FIG. 4 is plotted for a cam shape in which the radius increases quickly near its minimum radius, increases slowly as it approaches its maximum radius, then quickly decreases back to the minimum radius. This shape has an increasing radius for about 270 degrees and a decreasing radius for the other 90 degrees . By having the increasing radius more than 180 degrees, it is possible to have part of each cam rotation with the load shared between the two belts, allowing smooth operation.

FIG. 4 also shows that this cam design has a large region where each degree of cam rotation results in a nearly linear change in belt displacement. This shows that the output force will be nearly constant and independent of cam position. The graph for belt B has been displaced by the amount that belt A would have moved the output load. Note that near points where the two graphs intersect, the slope of the belt A line is less than that of belt B, hence belt B is accelerating to catch up and take over the load from belt A. The shape of the cam can be changed to vary the output displacement vs. cam rotation angle as desired.

In braking mode, the cam moves the opposite direction, so it is like viewing FIG. 4 from right to left. The load starts out on belt B, but near the points where the two graphs intersect, belt A has a radius changing more slowly than belt B, so its support of the load drops off faster and the load is transferred to belt A.

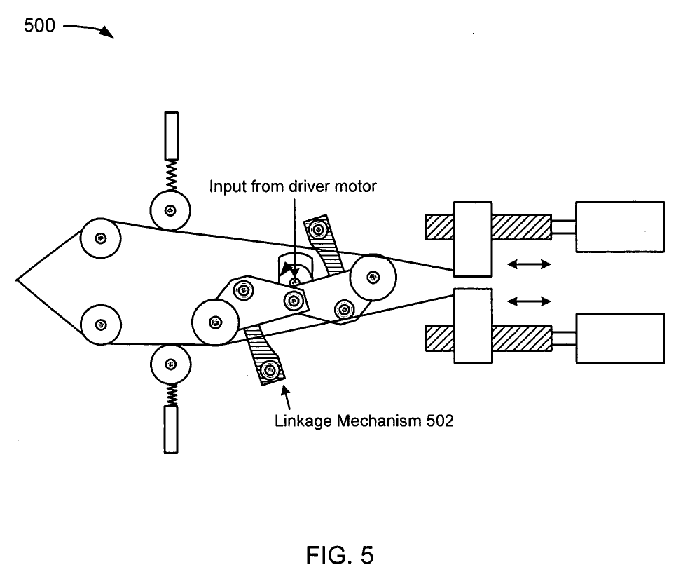

FIG. 5 shows another example of a variable ratio linear actuator system 500. FIG. 5 is intended to illustrate that different actuators can be used to take advantage of techniques described herein. Specifically, the linear actuator 500 is similar to the actuator 200 (FIG. 2) but replaces a ball screw actuator with a linkage mechanism 502. Operation of the linkage mechanism 502 is described more fully in the co-pending patent application entitled “Deflector Assembly,” which has been incorporated by reference.

FIGS. 6A and 6B show another example of a variable ratio actuator 600 system. The system 600 includes lead screw motors 602, screw driven slides 604, driven carriages 606, passive carriages 608, cables 610, an output tendon 612, a driver motor 614, and deflectors 616. The lead screw motors 602 drive the screw driven slides 604 on which the driven carriages 606 and the passive carriages 608 are operationally connected. The cables 610 are coupled between the driven carriages 606 and the passive carriages 608, and the passive carriages 608 are coupled to the output tendon 612 (which may, in an alternative, be an output linkage). A driver motor 614 drives the deflectors 616 to deflect the cables 610 and the deflection of the cables is provided to the output tendon 612.

In an illustrative embodiment, the screw driven slides 604 are Kerk Rapid Guide Screw slides. A screw driven slide, such as the Kerk Rapid Guide Screw, includes a lead screw 618, a slide 620, a carriage guided by the bearings and driven by the lead screw (606), and optional addition passive carriages that are guided by the linear bearing but not driven by the lead screw (608). In the system 600, two screw driven slides 604 are used, each with one driven carriage 606 and one passive carriage 608. The passive carriages 608 are coupled to the output tendon 612. The cables 610 couple each driven carriage 606 with its corresponding passive carriage 608. The screw driven slide 604 and cable 610 are long enough to allow both carriages to move back and forth for the maximum displacement of the output.

In an illustrative embodiment, a driver mechanism (e.g., the driver motor 614 and deflectors 616) is fixed at a point between the carriages. When the driver mechanism is activated, one of the cables 610 is deflected and one passive carriage 608 is pulled towards its stopped driven carriage 606. During this phase, the other lead screw is rotated by its associated motor 602 to pull slack from the other cable 610. Then the process repeats with the opposite driver. Hence the two driven carriages 606 will take turns pulling the passive carriages 608 as all carriages move to the right.

In an illustrative embodiment, two belt deflection systems are substantially co-planar. Advantageously, the overall thickness of a co-planar system constructed according to the techniques described here may be the same as for a single one of the deflection systems.

FIG. 6B shows a cam follower mechanism that can be used with the screw driven slide of FIG. 6A or other actuators. As the cam rotates, a follower arm rotates up and down, moving the deflector arm up and down around a pivot point. As the pivot point moves to the right, the pulley has less maximum displacement on each cycle. The arm may also be designed with spring steel to provide and automatic mechanism to reduce the displacement as the load increases. A device such as the cam follower mechanism of FIG. 6B is described more thoroughly in the co-pending U.S. patent application entitled “Deflector Assembly,” which has been incorporated by reference.

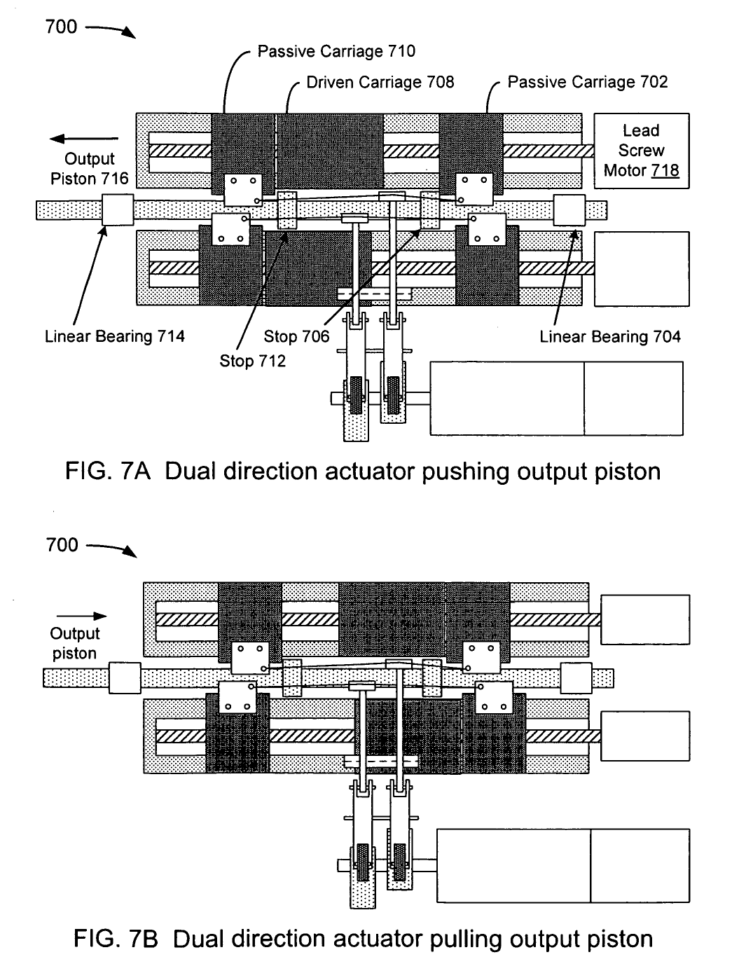

FIGS. 7A and 7B depict an example of linear actuator system 700 with an output piston that is pushed or pulled depending on the position of a lead-screw driven carriage. The system 700 is intended to illustrate a dual direction linear actuator. The system 700 is similar to that of FIG. 6A. So only a portion of the components have reference numbers; the remainder are sufficiently similar to that of FIG. 6A that more detailed explanation is redundant.

In the example of FIGS. 7A and 7B, the system 700 includes a passive carriage 702, a linear bearing 704, a stop 706, a driven carriage 708, a passive carriage 710, a stop 712, a linear bearing 714, and an output piston 716. A pair of slides each has a driven carriage plus two passive carriages. Where, for illustrative purposes, a distinction is made between the carriages of the two slides, one slide is referred to as the top slide (and the carriages as top carriages) and the other is referred to as the bottom slide (and the carriages as bottom carriages).

In the example of FIGS. 7A and 7B, the passive carriages 702 and 710 are connected to each other by a flexible belt, cord, cable, or three-link chain. When the belt between the passive carriages 702, 710 is tight, the distance between the passive carriages 702, 710 is greater than the width of the driven carriage 708. The driven carriage 708 may be positioned as a brake for either passive carriage. The output piston 716 is supported by linear bearings 704, 714, allowing it to move in only one dimension. The passive carriages 702, 710 can push against stops 706, 712 operationally connected to the output piston 716.

In the example of FIG. 7A, the passive carriage 710 is prevented from moving to the right by the position of the driven carriage 708. When the top belt is deflected, the passive carriage 710 is held in place and the passive carriage 702 moves to the left. The passive carriage 702 rides against the stop 706 of the output piston 716 and the movement of the passive carriage 710 causes the output piston 716 to move to the left. Before the top belt is slack, the bottom belt applies force to the output piston 716 by pulling the bottom right passive carriage toward the stationary bottom left passive carriage braked by the bottom driven carriage. While the bottom belt is driving the load, the top lead-screw motor turns to move its driven carriage in the direction of the output movement, thereby tightening the belt in preparation for the next cycle.

FIG. 7B shows the same mechanism as FIG. 7A, but with the driven carriage riding against the right passive carriages. In this configuration, deflections of the belts cause the left passive carriages to move to the right. The left carriages ride against the left stop of the output piston to couple the force from the carriages and to cause the output piston to move to the right. Thus position of the lead-screw driven carriages control the direction of movement of the output piston. Sensors (not shown) can detect the force on the output piston and these sensors may be used for feedback control of the system 700.

When the driven carriage 708 is moved from its position in FIG. 7A to its position in FIG. 7B, it passes through a region where it engages neither passive carriage 702, 710. If both the top and bottom driven carriages are in this mid-position, the output piston can move freely, even if one of the top or bottom stops 706, 712 are in contact with a passive carriage. As long as neither driven carriage 708 impedes the movement of one of the passive carriages, the output piston may pull the passive carriages in either direction, or if neither stop is in contact, the movement of the output piston causes no movement in the passive carriages. The actuator thus allows free movement up to the point where the driven carriage again is in contact with a passive carriage. The free movement mode can be extended to the full range of the linear actuator with a control system that senses the position of the output carriages and adjusts the position of the driven carriages via the lead screw motors to keep the driven carriage from coming into contact with a passive carriage.

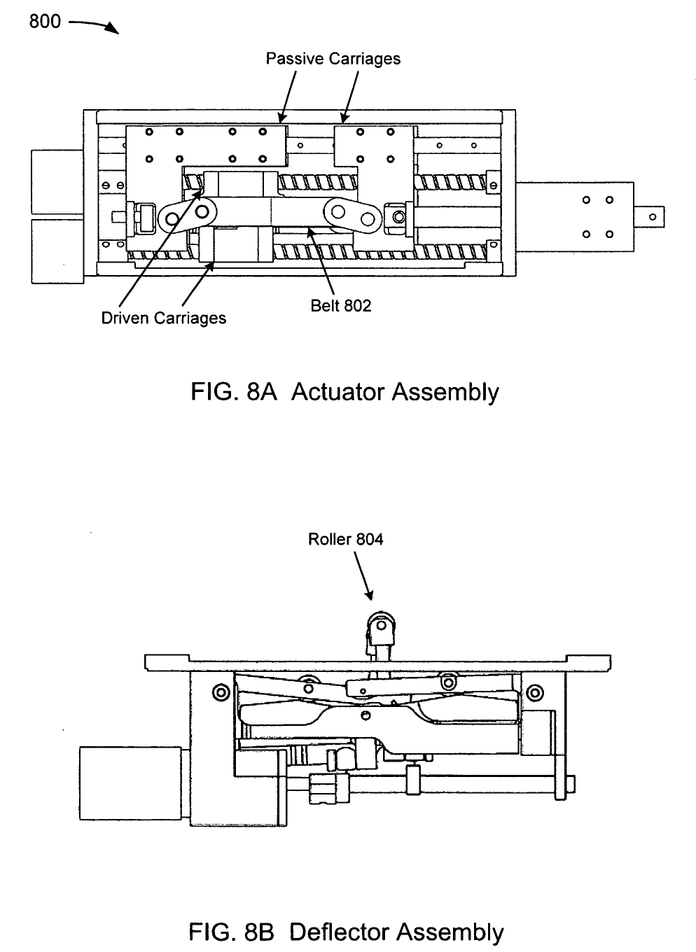

FIGS. 8A and 8B depict drawings of a specific implementation of a linear actuator system 800. The system 800 is conceptually similar to that of FIGS. 7A and 7B, but the sliders are placed back-to-back instead of in the same plane as shown in FIGS. 7A and 7B. Advantageously, when first and second belt deflection systems are substantially in parallel, the overall height of the system may be the same as for a single deflection system.

In the example of FIGS. 8A and 8B, the belt includes a three-link chain. Advantageously, the three-link chain, dependent upon the implementation, can be stronger, lighter, quieter, and less stretchy than a flexible belt. The three-link chain can have improved durability, control, or other characteristics, as well.

In the example of FIGS. 8A and 8B, in an illustrative embodiment, the deflector assembly enables bidirectional operation with a single deflector on each belt. With a rotary actuator, for example, two deflectors may be needed per belt (e.g., one on an upper belt and one on a lower belt) to apply force in both output directions. The moving fulcrum design of the example of FIGS. 8A and 8B is capable of continuous force over a wide range of ratios. It may be noted that although the deflector assembly depicted in the example of FIGS. 8A and 8B is significantly different from that of FIGS. 7A and 7B, the deflector assembly uses the principle of a moving fulcrum, as in the example of FIGS. 7A and 7B.

In an illustrative embodiment, belt support bearings are arranged above the belt instead of next to the belt. This cuts the thickness of the device. It may be noted that the support bearings could be arranged below the belt to gain similar advantages. Moreover, the drive motor can be arranged with its longest dimension in parallel to the belt. This facilitates construction of a thinner actuator and may allow a standard gearhead to be used on the drive motor. The gearhead ratio can be picked to keep the highest speed of the cam low enough to avoid problems with vibration or noise.

In the example of FIGS. 8A and 8B, the top of the deflector assembly (FIG. 8B) couples to the bottom of the actuator assembly (FIG. 8A) with the deflector roller 804 pushing on the belt 802. Not shown are the back side sliders and belt. However, the front and back belts look similar and operate similarly, but 180 degrees out of phase.

The invention is not limited to the specific embodiments described. The number of belts, brakes and drivers are not restricted to the number shown and may be increased. The belts can be implemented by chains, timing belts, steel belts, V-belts, cables, or any other type of flexible material. The materials used in construction are not limited to the ones described. In an embodiment, the ratio adjusting mechanism allows for an external control to set the desired ratio via mechanical, electrical, hydraulic or other means for adjusting the pivot point of a cam follower mechanism or other applicable device.

As used herein, the term “cam device” means a cam or a cam with a follower. Accordingly, if a cam device is coterminous with, for example, an actuator belt, that means the cam may or may not be coterminous, but a cam follower or some other component of the cam device is coterminous with the, for example, actuator belt.

As used herein, the term “belt support” means a mechanism that holds the end of a belt. By way of example but not limitation, a belt support may include a passive carriage riding on a linear bearing.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system comprising:
an output shaft;
a first belt deflection system including:
a first lead screw motor;
a first lead screw driven by the lead screw motor;
a first brake positionable by the first lead screw;
a first belt coupled to a first belt support and a second belt support;
a first deflector;
wherein, in operation, force is applied from the first brake to a belt support brake interaction point coupled to the first belt support; the first deflector deflects the belt; force is applied to the output shaft from a belt support output interaction point coupled to the second belt support;
a second belt deflection system including:
a second lead screw motor;
a second lead screw driven by the lead screw motor;
a second brake positionable by the lead screw;
a second belt coupled to a third belt support and a fourth belt support;
a second deflector;
wherein, in operation, force is applied from the second brake to a belt support brake interaction point coupled to the third belt support; the deflector deflects the belt; force is applied to the output shaft from a belt support output interaction point coupled to the fourth belt support.

2. The system of claim 1, wherein the first belt deflection system and the second belt deflection system operate out of phase with each other to apply substantially continuous force to the output shaft.

3. The system of claim 1, wherein the belt support brake interaction point coupled to the first belt support is a first brake interaction point and the belt support output interaction point coupled to the first belt support includes a first output interaction point, wherein:
the output shaft and first belt support have a second output interaction point;
the first brake and second belt support have a second brake interaction point;
in operation, force can be applied to the output shaft in either direction.

4. The system of claim 1, wherein the first belt includes a three-link chain.

5. The system of claim 1, further comprising belt support bearings positioned vertically with respect to the belt.

6. The system of claim 1, wherein the first deflector is a moving fulcrum deflector capable of bidirectional operation.

7. The system of claim 1, wherein the first belt deflection system and the second belt deflection system are substantially co-planar.

8. The system of claim 1, wherein the first deflection system and the second deflection system are substantially in parallel.

9. The system of claim 1, further comprising a shared driver motor with a motor shaft substantially parallel to tracks supporting the belt supports.

10. The system of claim 1, further comprising a shared driver motor including a gearhead to reduce output speed.

11. The system of claim 1, further comprising a shared driver motor including a gearhead with a selectable gearhead ratio.

12. The system of claim 1, further comprising using the first deflector to deflect the belt when operating in a first direction, and using the first deflector to deflect the belt when operating in a second direction.

13. A system comprising:
a means for positioning a brake to prevent movement of a braked belt support;
a means for deflecting a belt to pull an output belt support towards the braked belt support;
a means for moving an output shaft in response to interaction of the output belt support and the output shaft.

14. The system of claim 13, wherein the brake is a first brake, further comprising:
a means for positioning a second brake to prevent movement of the output belt support, wherein the output belt support becomes a new braked belt support;
a means for releasing the first brake, wherein the braked belt support becomes a new output belt support;
wherein the means for deflecting the belt deflects the belt to pull the new output belt support towards the new braked belt support;
wherein the means for moving the output shaft moves the output shaft in response to interaction of the new output belt support and the output shaft.

15. The system of claim 14, further comprising a means for controlling the means for positioning the first brake and the means for positioning the second brake in accordance with a free movement mode.

16. A method comprising:
assigning a first belt support as a braked belt support;
assigning a second belt support as an output belt support;
positioning a brake to prevent movement of the braked belt support;
deflecting a belt to pull the output belt support towards the braked belt support;
moving an output shaft in response to interaction of the output belt support and the output shaft.

17. The method of claim 16, wherein the output shaft is moved in a first direction in response to the interaction of the output belt support and the output shaft, further comprising:
reassigning the first belt support as the new output belt support;
reassigning the second belt support as the new braked belt support;
repositioning the brake to prevent movement of the new braked belt support;
deflecting the belt to pull the new output belt support towards the new braked belt support;
moving the output shaft in a second direction in response to interaction of the new output belt support and the output shaft.

18. The method of claim 16, wherein the brake is a first brake, further comprising:
positioning a second brake to prevent movement of the output belt support, wherein the output belt support becomes a new braked belt support;
releasing the first brake, wherein the braked belt support becomes a new output belt support;
deflecting the belt to pull the new output belt support towards the new braked belt support;
moving the output shaft in response to interaction of the new output belt support and the output shaft.

19. The method of claim 16, further comprising continuous output movement by repeating the positioning step on a second brake and the deflecting and moving steps on second belt supports, then repeating the sequence from the beginning.

20. The method of claim 16, further comprising positioning first and second brakes to make neither an output brake support.
